(19) United States
(12) Patent Application Publication
(10) Pub. No.: US 2026/0270346 A1
(43) Pub. Date: Sep. 10, 2026

(54) System and Method for High Fidelity Handovers

(71) Applicant: Nextiva, Inc., Scottsdale, AZ (US)

(72) Inventors: Raymond Allan Harker, Phoenix, AZ (US); Senthil Velayutham, Frisco, TX (US); Chinmay Joshi, Manor, TX (US); Danielle Kavanaugh, Park Ridge, IL (US)

(21) Appl. No.: 19/464,069

(22) Filed: Jan. 29, 2026

Related U.S. Application Data
(60) Provisional application No. 63/752,242, filed on Jan. 31, 2025.

(51) Int. Cl. H04M 3/51; G06F 16/215; G06F 40/166; G06Q 30/015

(52) U.S. Cl. CPC H04M 3/5191; G06F 16/215; G06F 40/166; G06Q 30/015; H04M 3/5175; H04M 2201/42

(57) ABSTRACT

A system and method are disclosed for high fidelity customer service handovers. The method comprises monitoring interactions between customer service systems and end user systems, determining an interaction of the monitored interactions that will be handed over from a first customer service system to a second customer service system, collecting content data from the interaction, generating an artificial intelligence summary of the interaction based on the collected content data, and generating a user interface on the second customer service system comprising the artificial intelligence summary.

### CROSS-REFERENCE TO RELATED APPLICATIONS

The present disclosure is related to that disclosed in the U.S. Provisional Application No. 63/752,242, filed Jan. 31, 2025, entitled “System and Method for High Fidelity Handovers.” U.S. Provisional Application No. 63/752,242 is assigned to the assignee of the present application. The present invention hereby claims priority under 35 U.S.C. § 119(e) to U.S. Provisional Application No. 63/752,242.

### TECHNICAL FIELD

The present disclosure relates generally to customer interaction management and specifically to smoothly handing off customer service interactions between different customer service agents.

### BACKGROUND

In customer support and customer service environments, such as call centers, support centers and the like, one customer service agent may pick up a customer interaction or ticket started or worked by a different customer service agent or a customer service agent may pick up a ticket started by a chatbot or other artificial intelligence (AI) agent, which may be called a “hand off” of the interaction or ticket. When an interaction is handed off, the customer frequently has to repeat information given to the first agent, and the second agent may receive only partial or incomplete information about the customer's issue, which leads to the second agent spending significant time reading the entire case to understand what happened. In existing customer service systems, for cases with text content, such as email, text message, or SMS support, when a new agent takes over a ticket, the new agent will need to read the entire case to see what has already happened and determine what the next best steps are. For non-text-based cases, such as calls, there is even less visibility into the previous actions of another agent. Even when existing customer service systems provide call summaries for the new agent to refer to, there typically is not time to review such summaries during a time-sensitive call. For these reasons and more, existing customer service systems create inefficient workflows for customer service agents, encourage errors and miscommunications in customer interactions and require frequent manual intervention by agents and supervisors alike, all of which is undesirable.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 illustrates an example interaction system, according to an embodiment;

FIG. 2 illustrates the handoff system and an agent system of FIG. 1 in greater detail, according to an embodiment;

FIG. 3 illustrates an example method for high fidelity customer service handovers, according to an embodiment;

FIG. 4 illustrates a summary display, according to an embodiment;

FIG. 5 illustrates a closed interaction display, according to an embodiment;

FIG. 6 illustrates a handoff display, according to an embodiment;

FIG. 7 illustrates a share display, according to an embodiment; and

FIG. 8 illustrates an AI handoff display, according to an embodiment.

### DETAILED DESCRIPTION

Aspects and applications of the invention presented herein are described below in the drawings and detailed description of the invention. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

Embodiments provide systems and methods for performing smooth handovers or handoffs in customer service environments. Embodiments may use artificial intelligence (AI) or machine learning (ML) to summarize key information in a customer service interaction to enable a new agent to continue working on the interaction, losing no context during handoff and allowing the new agent to pick up the interaction with less time spent in review. Embodiments enable customer service agents to view interaction data irrespective of the format the interaction takes and provide agents with relevant information to help with decision making. Embodiments may generate and present short summaries of interactions that may be quickly consumable by customer service agents when an interaction is handed off or shared. Embodiments enable interaction data and summaries to be shared across different channels, including one-on-one chats, group chats, emails, and third-party integrations, allowing customer service agents not directly interfacing with a customer service system or agent system to stay informed about customer service interactions. Embodiments provide AI summaries of critical information from interactions including phone calls, video calls or other non-text customer interactions.

Use of embodiments may allow customer service agents to receive summaries of customer service interactions including key topics, sentiments, channels of interactions, key commitments and responses from prior agent(s), sample statements or callouts, interaction histories, determined interaction importance and suggested interaction starts or openings. Embodiments may provide agents with an ability to request clarification from a previous agent and to navigate from provided summaries to specific details. Use of embodiments may allow customer service agents to pick up a handed-over interaction more quickly without losing context, regardless of interaction channel and without requiring the new agent to review the entire interaction history. Use of embodiments may lead to more efficient customer service management including reduced time to solve customer issues and improved customer satisfaction.

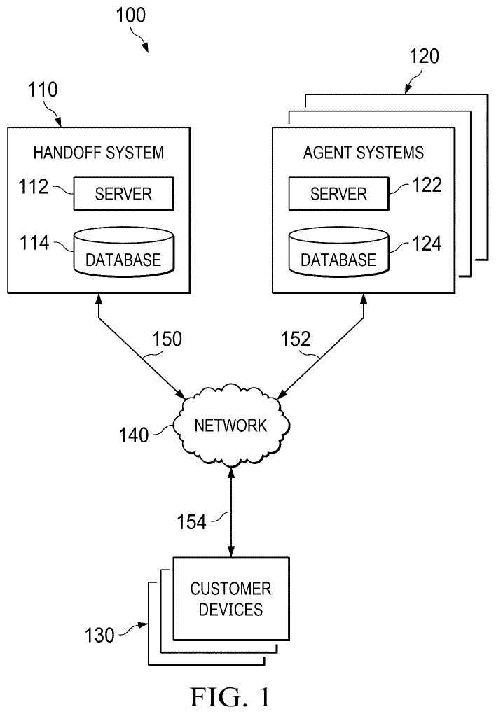

FIG. 1 illustrates interaction system 100, according to an embodiment. Interaction system 100 comprises handoff system 110, one or more agent systems 120, one or more customer devices 130, network 140 and one or more communication links 150-154. Although a single handoff system 110, one or more agent systems 120, one or more customer devices 130, a single network 140 and one or more communication links 150-154 are shown and described, embodiments contemplate any number of handoff systems 110, agent systems 120, customer devices 130, networks 140 or communication links 150-154, according to particular needs.

According to an embodiment, handoff system 110 comprises server 112 and database 114. Although handoff system 110 is illustrated in FIG. 1 as comprising a single server 112 and a single database 114, embodiments contemplate handoff system 110 including any suitable number of servers 112 or databases 114, serverless computing options or data stores, internal to or externally coupled with handoff system 110, according to particular needs. For the purposes of this disclosure, all instances of “server” are understood to include, according to embodiments, one or more embodiments of servers, serverless computing options, and/or other computing solutions, and all instances of “database” are understood to include, according to embodiments, databases, datastores, data stores, and/or other data storage systems, according to particular needs. In embodiments, handoff system 110 may be used to monitor interactions between agent systems 120 and one or more customer devices 130 customer devices 130 and to perform smooth, high fidelity handovers of interactions between one or more agent systems 120, as described in further detail below.

According to an embodiment, one or more agent systems 120 may be used by customer service agents, customer experience agents or any other agent or any entity which communicates with customers, such as call centers, help desks or other entities. In embodiments, agent systems 120 may be used to communicate with customers of an entity operating agent system 120 or the customers of another entity. In embodiments, agent systems 120 may comprise or be operated by one or more machine learning (ML) or artificial intelligence (AI) agents configured to respond to customer communications. One or more agent systems 120 may operate on one or more computers comprising one or more servers 142 and one or more databases 144 or other data storage arrangements at one or more locations which are integral to or separate from the hardware and/or software that supports interaction system 100.

According to an embodiment, one or more customer devices 130 comprise devices or systems associated with customers or other end users such as, for example, customers, buyers, sellers, retailers, or any other business, enterprise or entity using customer service or customer relationship services provided by interaction system 100 and agent systems 120. In embodiments, customer devices 130 may include communication devices that provide a channel of communication between customers and agents systems 120, such as voice channels, video channels, email channels, text channels, chat channels or any other communication channel.

According to an embodiment, network 140 includes the Internet, telephone lines, any appropriate local area networks LANs, MANs, or WANs, and any other communication network coupling handoff system 110, agent system 120 and customer devices 130. For example, data may be maintained by handoff system 110, agent systems 120 and customer devices 130 at one or more locations external to handoff system 110, agent systems 120 and customer devices 130 and made available to handoff system 110, agent systems 120 and customer devices 130 using network 140 or in any other appropriate manner. Those skilled in the art will recognize that the complete structure and operation of network 140 and other components within interaction system 100 are not depicted or described. Embodiments may be employed in conjunction with known communications networks and other components.

According to an embodiment, handoff system 110, agent systems 120 and customer devices 130 are coupled with network 140 using the one or more communications links 150-154, which may be any wireless or other link suitable to support data communications between handoff system 110, agent systems 120 and customer devices 130 and network 140. Although three communication links 150-154 are shown as generally coupling handoff system 110, agent systems 120 and customer devices 130 with network 140, handoff system 110, agent systems 120 and customer devices 130 may communicate directly with each other according to particular needs.

According to an embodiment, handoff system 110, agent systems 120 and customer devices 130 may each operate on one or more computers or computer systems that are integral to or separate from the hardware and/or software that support interaction system 100. In addition or as an alternative, one or more users, such as customers, end users or agents may be associated with interaction system 100 including handoff system 110, agent systems 120 and customer devices 130. These one or more users may include, for example, one or more computers programmed to autonomously handle monitoring customer relationships and/or one or more related tasks within interaction system 100. As used herein, the term “computer” or “computer system” includes any suitable input device, such as a keypad, mouse, touch screen, microphone, or other device to input information. Any suitable output device that may convey information associated with the operation of interaction system 100, including digital or analog data, visual information, or audio information. Furthermore, the one or more computers may include any suitable fixed or removable non-transitory computer-readable storage media, such as magnetic computer disks, CD-ROM, or other suitable media to receive output from and provide input to interaction system 100. The one or more computers may also include one or more processors and associated memory to execute instructions and manipulate information according to the operation of interaction system 100.

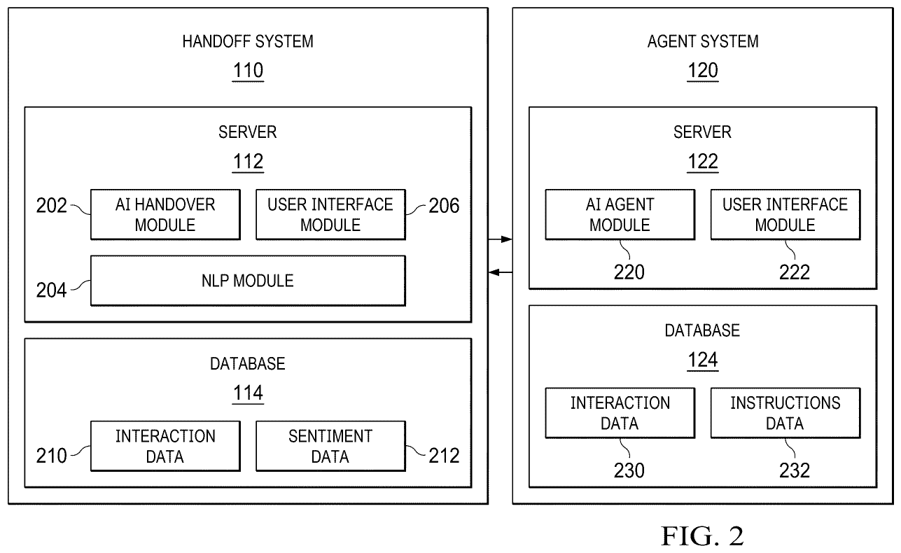

FIG. 2 illustrates handoff system 110 and agent system 120 of FIG. 1 in greater detail, according to an embodiment. Handoff system 110 may comprise server 112 and database 114, as described above. Although handoff system 110 is shown as comprising a single server 112 and a single database 114, embodiments contemplate any suitable number of servers or databases internal to or externally coupled with handoff system 110.

Server 112 comprises AI handover module 202, NLP module 204 and user interface module 206. Although server 112 is illustrated and described as having several distinct and discrete modules performing various functions or tasks, embodiments contemplate the functions of server 112 and/or the various modules being performed by any number of software or hardware modules, applications or sub-routines including fewer than or more than the number of illustrated modules, according to needs. Although server 112 is shown and described as comprising a single AI handover module 202, a single NLP module 204 and a single user interface module 206, embodiments contemplate any suitable number or combination of these located at one or more locations, local to, or remote from handoff system 110, such as on multiple servers or computers at one or more locations in interaction system 100.

Database 114 may comprise one or more databases or other data storage arrangements at one or more locations, local to, or remote from, server 112. Database 114 comprises, for example, interaction data 210 and sentiment data 212. Although database 114 is shown and described as comprising interaction data 210 and sentiment data 212, embodiments contemplate any suitable number or combination of data, located at one or more locations, local to, or remote from, handoff system 110, according to particular needs. While the illustrated data is shown within a single database 114 for simplicity of explanation, in embodiments data may be stored separately either physically or logically for data security, data privacy, data integrity and confidentiality purposes.

In an embodiment, AI handover module 202 monitors all open interactions between agents associated with agent system 120 including human agents and AI agents, and customers or end users associated with customer devices 130 to determine when or if an interaction should be handed over or handed off to a different customer service agent. In this context, handing over an interaction may include adding a new agent or supervisor to an existing interaction as well as fully transferring responsibility of an interaction to a new agent or supervisor. After determining that an interaction will be handed off, AI handover module 202 collects data from the interaction to be handed off, including content of the interaction in text, video, audio or any other data format. AI handover module 202 may then analyze the content of an interaction to generate an AI summary of the interaction. For example, AI handover module 202 may utilize one or more AI or ML models or algorithms to process text data to generate a summary of the text and may also auto-transcribe video data or audio data into text for processing by such modules. AI handover module 202 may then send the AI summary to user interface module 206 to generate and display a user interface for the new agent including the AI summary.

In an embodiment, natural language processing (NLP) module 204 performs one or more NLP processing techniques to determine a sentiment score for a customer service interaction. For example, NLP module 204 may utilize one or more NLP modules to analyze text input to determine whether the text input is positive, neutral or negative, although NLP module 204 may also analyze video input, audio input or may perform speech-to-text processing to generate text input from video input or audio input in order to analyze the sentiment of the video input or the audio input. The determined sentiment scores for the interactions may be used, for example, to sort the interactions based on a priority of resolving interactions, such as to prioritize the resolution of interactions with negative sentiment scores or to display determined sentiments to users of handoff system 110 or agent systems 120. When processing text or other natural language data of the NLP module may utilize one or more NLP algorithms, models or techniques, including support vector machines (SVMs), term frequency (TF) models, term frequency inverse document frequency (TF-IDF) models, bag-of-words models, logistic regression models, Naïve Bayes models, decision trees, hidden Markov models, convolutional neural networks, recurrent neural networks, auto-encoder models or NLP transformers, although other NLP techniques may be used according to needs.

In an embodiment, user interface module 206 generates and displays a user interface (UI), such as, for example, a graphical user interface (GUI), that displays interaction data, sentiment data or any other data of handoff system 110 in tables, charts, graphs, histograms, or any other visual representations of data of handoff system 110. According to embodiments, user interface module 206 displays a GUI comprising interactive graphical elements for selecting interactions monitored by AI handover module 202 and, in response to the selection, allowing the user to pick up the interaction by communicating with the customer or with the customer service agent, according to needs. In embodiments, user interface module 206 may also display a GUI comprising interactive graphical elements for selecting data of any kind stored in database 114, and, in response to the selection, may display the selected data on one or more display devices. In embodiments, user interface module 206 may generate non-visual interfaces, such as voice-based personal assistants or email messages or other text-based messages, and present interaction information and intervention options to users over such voice-based or text-based interfaces.

In an embodiment interaction data 210 comprises data of interactions between customer service agents and customers and end users. For example, interaction data 210 may comprise agent names or IDs of both human and AI agents, end user or customer IDs including contact information, queue or interaction category such as sales, support, VIP customers or other categories, communication channel such as call, chat, SMS, video call or any other communication channel, interaction duration, transcripts or other content of the interactions including recorded video or audio and summaries of interaction content as described in further detail above. In embodiments, interaction data 210 may be generated by AI handover module 202 by monitoring interactions between customer devices 130 and agent systems 120. Although interaction data 210 is shown in database 114, in other embodiments interaction data 210 may be stored in databases 144 of agent systems 120, databases 134 of cloud data stores 130 or any other database or data storage device without or outside of interaction system 100.

In an embodiment sentiment data 212 comprises sentiment scores for interactions, which may be classified into one or more sentiment categories, such as positive, neutral or negative, although in other embodiments or more fewer sentiment categories may be used, according to needs. The sentiment scores may be based on an AI or ML sentiment analysis of text or other natural language data and may represent an estimation of an end user's or customer's attitude or feeling towards the interaction, such as whether the interaction has been generally positive or if the interaction has been generally negative. In embodiments, sentiment data 212 may be generated by NLP module 204 and used by user interface module 206 to display sentiment scores to users.

Agent system 120 may comprise server 122 and database 124, as described above. Although agent system 120 is shown as comprising a single server 122122 and a single database 124, embodiments contemplate any suitable number of servers 122 or databases 124 internal to or externally coupled with handoff system 110.

Server 122 comprises AI agent module 220 and user interface module 222. Although server 122 is illustrated and described as having several distinct and discrete modules performing various functions or tasks, embodiments contemplate the functions of server 122 and/or the various modules being performed by any number of software or hardware modules, applications or sub-routines including fewer than or more than the number of illustrated modules, according to needs. Although server 122 is shown and described as comprising a single AI agent module 220 and a single user interface module 222, embodiments contemplate any suitable number or combination of these located at one or more locations, local to, or remote from agent system 120, such as on multiple servers or computers at one or more locations in interaction system 100.

Database 124 may comprise one or more databases or other data storage arrangements at one or more locations, local to, or remote from, server 122. Database 124 comprises, for example, interaction data 230 and instructions data 232. Although database 124 is shown and described as comprising interaction data 210 and instructions data 232, embodiments contemplate any suitable number or combination of data, located at one or more locations, local to, or remote from, agent system 120, according to particular needs. While the illustrated data is shown within a single database 114 for simplicity of explanation, in embodiments data may be stored separately either physically or logically for data security, data privacy, data integrity and confidentiality purposes.

In an embodiment, AI agent module 220 serves as an AI customer service agent to automatically process and respond to messages or any other communications from customers or end users. For example, AI agent module 220 may utilize one or more NLP processing techniques to analyze text input and natural language input from end users, such as speech, utterances, body language or any other natural language input in order to determine the meaning of end user messages and generate response to such input. In embodiments, AI agent module 220 may receive instructions from handoff system 110 to steer interactions in different directions, such as by suggesting new resolution options to present to end users or providing additional information or explanations to end users. In embodiments where a human agent is conducting an interaction with an end user, AI agent module 220 may perform interaction assistant functions, such as by monitoring end user sentiment, providing summaries of interaction content and providing the human agent with response options or templates.

In an embodiment, user interface module 222 generates and displays a user interface (UI), such as, for example, a graphical user interface (GUI), that displays interaction data, instructions data or any other data of agent system 120 in tables, charts, graphs, histograms, or any other visual representations of data of agent system 120. According to embodiments, user interface module 222 displays a GUI comprising interactive graphical elements for selecting interactions and, in response to the selection, allowing the user to continue an interaction such as by entering messages to a customer or end user, or to view further details of the interaction and instructions sent from a supervisor. In embodiments, user interface module 222 may also display a GUI comprising interactive graphical elements for selecting data of any kind stored in database 124, and, in response to the selection, may display the selected data on one or more display devices. In embodiments, user interface module 222 may generate non-visual interfaces, such as voice-based personal assistants or email messages or other text-based messages, and present interaction information and instructions from supervisors to users over such voice-based or text-based interfaces.

In an embodiment interaction data 230 comprises data of interactions between customer service agents and customers and end users, including data by with the interactions may be sorted for priority of resolution. For example, interaction data 230 may comprise agent names or IDs of both human and AI agents, end user or customer IDs including contact information, queue or interaction category such as sales, support, VIP customers or other categories, communication channel such as call, chat, SMS, video call or any other communication channel, interaction duration, transcripts or other content of the interactions including recorded video or audio and summaries of interaction content as described in further detail above. In embodiments, interaction data 230 may be received from handoff system 110 or generated by AI agent module 220 by tracking interactions and may be used by AI agent module 220 to perform AI assistant functions for customer service agents as described in further detail above. Although interaction data 230 is shown database 124, in other embodiments interaction data 230 may be stored in database 114, databases 134 of cloud data stores 130 or any other database or data storage device within or outside of interaction system 100.

In an embodiment instructions data 232 comprises instruction data received by agent system 120 from handoff system 110 indicating intervention instructions by a supervisor. For example, instructions data 232 may include messages from supervisors to human agents indicating how to respond to end users and may also include prompts, instructions or commands to AI agents indicating how an interaction should be steered, additional resolution options that the AI agent should present to the end user or additional information that the AI agent should provide to the end user. In embodiments, instructions data 232 may be received from handoff system 110 and used by AI agent module 220 to conduct interactions with end users and by user interface module 222 to present instructions to human agents.

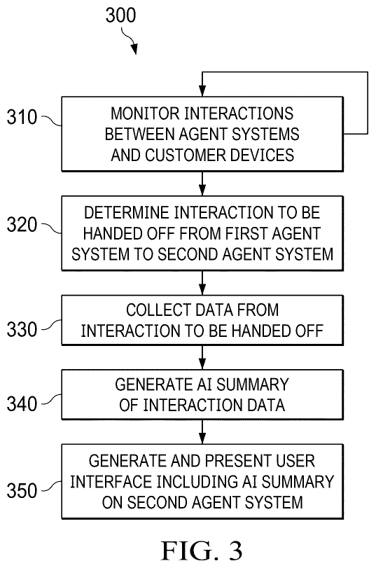

FIG. 3 illustrates example method 300 for high fidelity customer service handovers, according to an embodiment. Method 300 may be performed by a handoff system, such as handoff system 110 of FIG. 1. Method 300 proceeds by one or more activities 310-350, which although described in a particular order may be performed in one or more permutations, combinations, orders, or repetitions, according to particular needs. Various steps through method 300 may be weighted or rewarded in order to use data collected during the method as training data for one or more machine learning or artificial intelligence models.

At first activity 310 handoff system 110 monitors interactions between one or more agent systems 120 and one or more customer devices 130 and tracks data of the interactions including duration, sentiment and summaries of the interactions as described in further detail below. Handoff system 110 may monitor all interactions between all agent systems 120 or may only monitor interactions involving a subset of agent systems 120 assigned to handoff system 110. Handoff system 110 may continuously monitor interactions throughout the operation of method 400 in order to keep interaction data up to date throughout the display of information to users of handoff system 110.

At second activity 320 handoff system 110 determines an interaction of the monitored interactions that will be or is likely to be handed over from a first agent system 120 to a second agent system 120. For example, handoff system 110 may receive a request from a first agent system 120 to add a new agent to an interaction or to transfer an interaction to a new agent. In other cases, handoff system 110 may determine to handoff an interaction to a new agent based on analysis of the interactions, such as if a particular interaction has reached a high duration or has a low sentiment, according to configurable duration thresholds and sentiment thresholds.

At third activity 330 handoff system 110 collects data from the interaction determined to be handed over at second activity 320. For example, handoff system 110 may collect data including content of the interaction in text, video or audio according to the communication channel(s) used during the interaction. Handoff system 110 may then prepare the collected data for use by one or more AI or ML models, such as by cleansing and normalizing the collected data in preparation for natural language processing. For example, handoff system 110 may expand abbreviations, change case to be uniform, remove or add punctuation, verify text and remove stop words, although other actions may be performed to prepare the collected data for analysis.

At fourth activity handoff 340 system 110 generates an AI summary of the interaction based on the data collected at third activity 330. The AI summary may include information such as key requests or questions by the customer or end user, key commitments or responses made by the agent, text summaries of the interaction, sentiment of the customer or end user, summaries of interaction history and indications of interaction importance. In embodiments, the AI summary may also include suggested opening statements or opening comments for the new agent to use, including suggested customer appeasements, offers or any other instruction on how to proceed with the handed over interaction. The suggestions or instructions within the AI summary may be generated by handoff system 110 autonomously or may be written by a supervisor or manager, according to embodiments.

At fifth activity 350 handoff system 110 generates and presents a user interface, such as a GUI on the second agent system 120, wherein the user interface includes at least the AI summary generated at fourth activity 340. The user interface may be configured to allow the new agent to interact with the customer or end user, as well as allowing the new agent to contact the previous agent for clarifications or comments on the interaction. In embodiments, the user interface may be configured to allow the new agent to select portions of the AI summary to view details about the portions of the AI summary. For example, the user interface may be configured such that, if a new agent selects a “key commitment” of the interaction displayed in the AI summary, the user interface may be updated to show the history of log of the interaction including that key commitment in context.

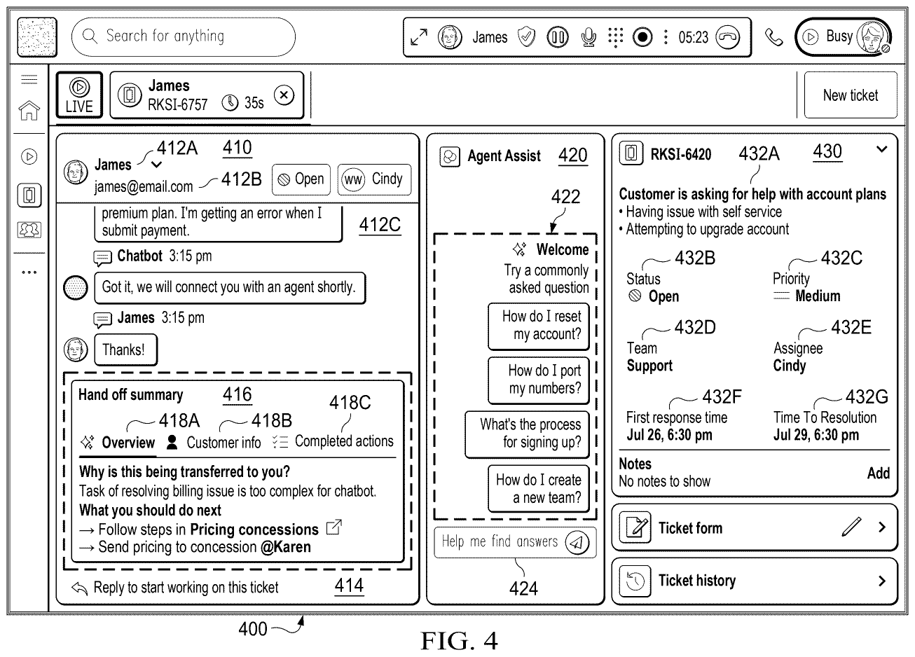

FIG. 4 illustrates summary display 400, according to an embodiment. Summary display 400 may be generated by agent system 120, and displayed via user interface module 222 as described in further detail above. In embodiments, summary display 400 may be displayed to a second customer service agent using a second agent system 120 who has received a handed over interaction from a first customer service agent.

In the illustrated example, summary display 400 includes various panels allowing the user to further examine details of an interaction, including activity panel 410, agent assist panel 420 and case ID panel 430. Activity panel 410 includes customer ID 412A, customer contact info 412B, transcript 412C, which is a transcript of the interaction between the customer and an AI agent associated with agent system 120 and input options displayed to the user including text input box 414 allowing the user to reply and add messages to the interaction. In this example, the AI agent has determined to hand off this interaction to the user. When the interaction is handed off, AI summary 416 of the interaction is generated and presented to the user, shown here below transcript 412C. AI summary 416 includes overview tab 418A, customer info tab 418B and completed actions tab 418C. In this case, overview tab 418A is selected, showing a relevant summary and suggested next steps for the user, including links to further instructions or other agents or supervisors to contact if needed.

Agent assist panel 420 includes list of commonly asked questions 422 that the agent may ask to the AI agent assistant. Agent assist panel 420 includes input options displayed to the user including private message input box 424 allowing the agent to ask questions to the AI agent assistant.

Case ID panel 430 includes information about the interaction, including issue summary 432A, status 432B, priority 432C, team 432D, current assignee 432E, first response time 432F and time to resolution 432G. In this case, the interaction detailed in case ID panel 430 may be a separate interaction from the interaction shown in activity panel 410 and agent assist panel 420.

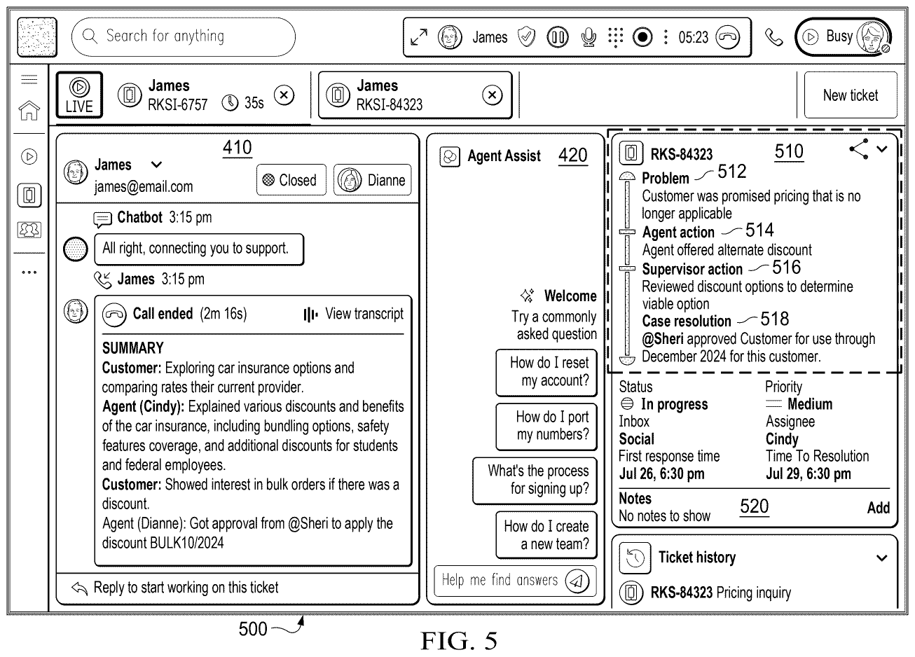

FIG. 5 illustrates closed interaction display 500, according to an embodiment. Closed interaction display 500 may be generated by agent system 120, and displayed via user interface module 222 as described in further detail above. In embodiments, closed interaction display 500 may be displayed to a customer service agent using agent system 120.

In the illustrated example, closed interaction display 500 includes various panels allowing the user to further examine details of one or more interactions, including activity panel 410 agent assist panel 420, as described above with respect to FIG. 4. Closed interaction display 500 further includes case ID panel 510, which includes information of a closed interaction. For example, if a customer has mentioned a previous interaction concerning the same issue of an active interaction, the agent assigned to the active interaction may wish to view details or the previous, or closed, interaction via case ID panel 510. In this case, case ID panel includes various AI-summarized information of the closed interaction, including problem summary 512, agent action summary 514, supervisor action summary 516 and case resolution summary 518, as well as, notes panel 520. In this case, the interaction detailed in case ID panel 510 may be the same interaction as the interaction detailed in activity panel 410, and AI summaries 512-618 may thus correspond to the AI summary shown in activity panel 410.

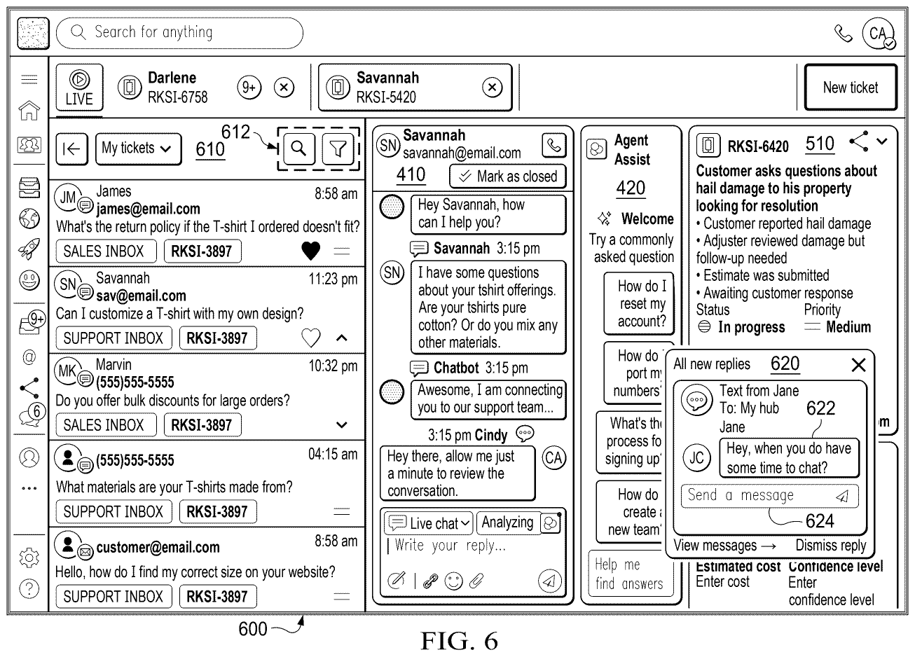

FIG. 6 illustrates handoff display 600, according to an embodiment. Handoff display 600 may be generated by agent system 120, and displayed via user interface module 222 as described in further detail above. In embodiments, handoff display 600 may be displayed to a customer service agent using agent system 120.

In the illustrated example, the handoff display includes various panels allowing the user to further examine details of one or more interactions, including activity panel 410, agent assist panel 420 and case ID panel 510 as described above with respect to FIGS. 4 and 5. Handoff display 600 further comprises list panel 610 message pop-out 620. List panel 610 show a list of interactions assigned to the user of handoff display 600, which may be sorted or filtered using sort and filter options 612 at the top of list panel 610. Message pop-out 620 includes summary 622 of a message received from a different agent as well as response options 624 for the user.

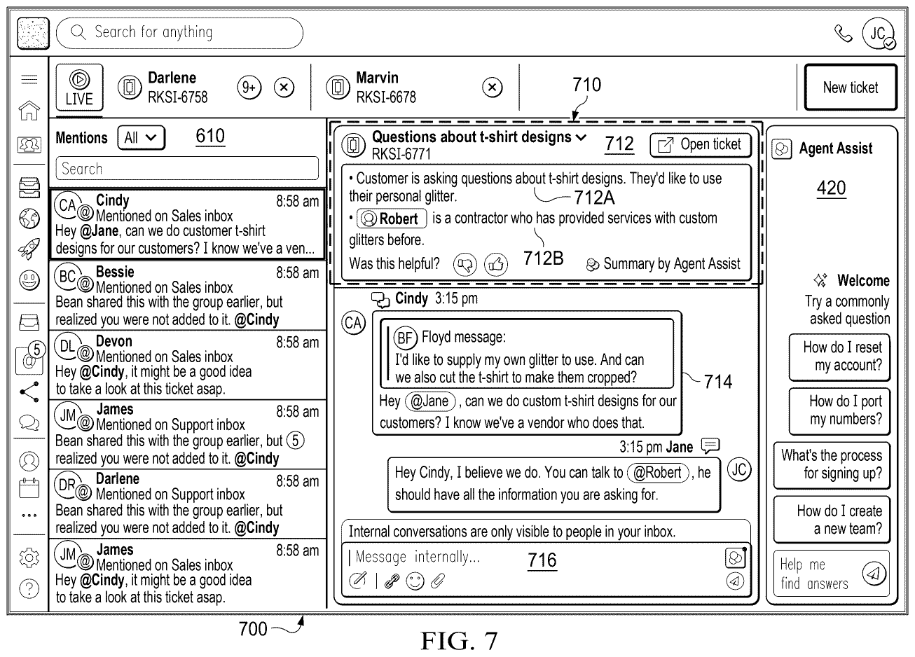

FIG. 7 illustrates share display 700, according to an embodiment. Share display 700 may be generated by agent system 120, and displayed via user interface module 222 as described in further detail above. In embodiments, share display 700 may be displayed to a customer service agent using agent system 120 who is receiving a question or request from a first agent.

In the illustrated example, share display 700 includes various panels allowing the user to further examine details of one or more interactions, including agent assist panel 420 and list panel 610 as further described with respect to FIGS. 4 and 6. Share display 700 further comprises activity panel 710 and agent assist panel 720. Activity panel 710 includes AI summary 712 of an interaction between a customer and a first customer service agent, transcript 714 of messages between the user and the first customer service agent and input options displayed to the user including text input box 716 allowing the user to reply and send messages to the first customer service agent. AI summary 712 includes a text summary of the interaction between the first customer service agent and the customer including key request 712A, as well as AI-generated suggestion of possible contact point 712B for this request. As illustrated, the user has taken the information of AI summary 712 to send a message to the first customer service agent directing the first customer service agent to contact point 712B who can provide further information about the customer's request.

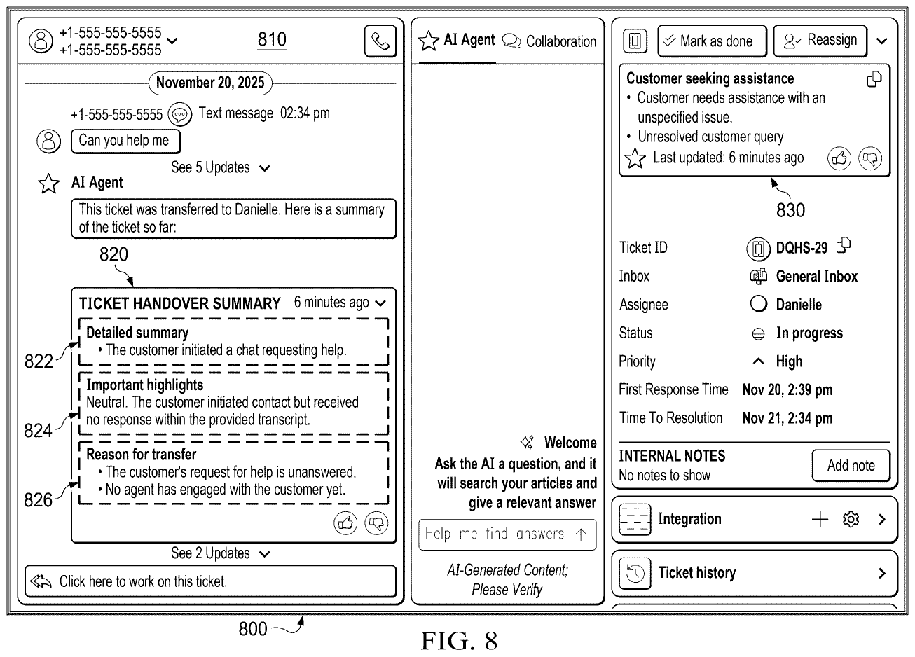

FIG. 8 illustrates AI handoff display 800, according to an embodiment. AI handoff display 800 may be generated by agent system 120, and displayed via user interface module 222 as described in further detail above. In embodiments, AI handoff display 800 may be displayed to a customer service agent using agent system 120. AI handoff display 800 may be used to provide the customer service agent with context or other information that can be used to respond to a particular customer service ticket or a set of customer service tickets.

AI handoff display 800 comprises chat panel 810, handover panel 820 and ticket summary panel 830. Chat panel 810 comprises a transcript of all messages received from a customer associated with a ticket, in this case, a customer identified by the phone number “+1-555-555-5555.” Chat panel 810 also includes messages sent by an AI agent or other AI-enabled assistant provided via handoff system 110. Within chap panel 810, handover panel 820 includes various summaries provided by the AI agent to assist the customer service agent in working on the customer service ticket. Handover panel 820 includes detailed summary panel 822, important highlights panel 824 and reason for transfer panel 826. AI handoff display 800 also includes ticket summary panel 830, which includes a top-level summary of the ticket and outstanding issues. In embodiments, the text shown in handover panel 820 and ticket summary panel 830 may be generated using one or more NLP techniques as described in further detail above and may be generated using a chat or message history for the ticket, which allows for any summaries presented to customer service agents to include all necessary context for response.

Reference in the foregoing specification to “one embodiment”, “an embodiment”, or “some embodiments” means that a particular feature, structure, or characteristic described in connection with the embodiment is included in at least one embodiment of the invention. The appearances of the phrase “in one embodiment” in various places in the specification are not necessarily all referring to the same embodiment.

While the exemplary embodiments have been shown and described, it will be understood that various changes and modifications to the foregoing embodiments may become apparent to those skilled in the art without departing from the spirit and scope of the present invention.

What is claimed is:

1. A system for high fidelity customer service handovers, comprising:
a computer, comprising a processor and memory, and configured to:
monitor interactions between one or more customer service systems and one or more end user systems;
determine an interaction of the monitored interactions that will be handed over from a first customer service system to a second customer service system;
collect content data from the interaction;
generate an artificial intelligence summary of the interaction based on the collected content data; and
generate a user interface on the second customer service system comprising the artificial intelligence summary.

2. The system of claim 1, wherein the content data comprises text, video or audio.

3. The system of claim 1, wherein the artificial intelligence summary comprises one or more of: requests or questions by a customer or an end user, commitments or responses made by an agent, text summaries of the interaction, sentiment of a customer or an end user, summaries of interaction history and indications of interaction importance.

4. The system of claim 1, wherein the computer is further configured to:
receive a selection of a word or words within the artificial intelligence summary of the interaction; and
in response to receiving the selection, display a history of a log of the word or words in context.

5. The system of claim 1, wherein the computer is further configured to:
cleanse and normalize the content data for use by one or more artificial intelligence models.

6. The system of claim 1, wherein the monitored interactions occur over one or more channels.

7. The system of claim 1, wherein interaction data of the monitored interactions comprise one or more of: agent names or identification of agents, contact information, a queue or interaction category, a communication channel, an interaction duration, and transcripts.

8. A computer-implemented method for high fidelity customer service handovers, comprising:
monitoring, by a computer comprising a processor and memory, interactions between one or more customer service systems and one or more end user systems;
determining, by the computer, an interaction of the monitored interactions that will be handed over from a first customer service system to a second customer service system;
collecting, by the computer, content data from the interaction;
generating, by the computer, an artificial intelligence summary of the interaction based on the collected content data; and
generating, by the computer, a user interface on the second customer service system comprising the artificial intelligence summary.

9. The computer-implemented method of claim 8, wherein the content data comprises text, video or audio.

10. The computer-implemented method of claim 8, wherein the artificial intelligence summary comprises one or more of: requests or questions by a customer or an end user, commitments or responses made by an agent, text summaries of the interaction, sentiment of a customer or an end user, summaries of interaction history and indications of interaction importance.

11. The computer-implemented method of claim 8, further comprising:
receiving, by the computer, a selection of a word or words within the artificial intelligence summary of the interaction; and
in response to receiving the selection, displaying, by the computer, a history of a log of the word or words in context.

12. The computer-implemented method of claim 8, further comprising:
cleansing and normalizing, by the computer, the content data for use by one or more artificial intelligence models.

13. The computer-implemented method of claim 8, wherein the monitored interactions occur over one or more channels.

14. The computer-implemented method of claim 8, wherein interaction data of the monitored interactions comprise one or more of: agent names or identification of agents, contact information, queue or interaction category, communication channel, interaction duration, and transcripts.

15. A non-transitory computer-readable storage medium embodied with software for high fidelity customer service handovers, the software when executed by a computer is configured to:
monitor interactions between one or more customer service systems and one or more end user systems;
determine an interaction of the monitored interactions that will be handed over from a first customer service system to a second customer service system;
collect content data from the interaction;
generate an artificial intelligence summary of the interaction based on the collected content data; and
generate a user interface on the second customer service system comprising the artificial intelligence summary.

16. The non-transitory computer-readable storage medium of claim 15, wherein the content data comprises text, video or audio.

17. The non-transitory computer-readable storage medium of claim 15, wherein the artificial intelligence summary comprises one or more of: requests or questions by a customer or an end user, commitments or responses made by an agent, text summaries of the interaction, sentiment of a customer or an end user, summaries of interaction history and indications of interaction importance.

18. The non-transitory computer-readable storage medium of claim 15, wherein the software when executed is further configured to:
receive a selection of a word or words within the artificial intelligence summary of the interaction; and
in response to receiving the selection, display a history of a log of the word or words in context.

19. The non-transitory computer-readable storage medium of claim 15, wherein the software when executed is further configured to:
cleanse and normalize the content data for use by one or more artificial intelligence models.

20. The non-transitory computer-readable storage medium of claim 15, wherein the monitored interactions occur over one or more channels.
